(19) United States
(12) Patent Application Publication
(10) Pub. No.: US 2024/0044238 A1
(43) Pub. Date: Feb. 8, 2024

(54) OPTIMAL BOTTOM HOLE ASSEMBLY CONFIGURATION

(71) Applicant: Baker Hughes Oilfield Operations LLC, Houston, TX (US)

(72) Inventors: Philipp Wolniak, Hannover (DE); Dennis Heinisch, Lachendorf (DE); Mathais Tergeist, Osnabrueck (DE)

(21) Appl. No.: 18/365,361

(22) Filed: Aug. 4, 2023

Related U.S. Application Data
(60) Provisional application No. 63/395,126, filed on Aug. 4, 2022.

(51) Int. Cl. E21B 43/30

(52) U.S. Cl. CPC E21B 43/30

(57) ABSTRACT

A method of defining a BHA design includes performing a numerical optimization process, which includes applying a bottom hole assembly (BHA) design criterion using a numerical optimization algorithm to identify a set of BHA designs selected from a plurality of possible BHA designs, evaluating multiple objective functions for each BHA design of the set of BHA designs based at least in part on a modeling constraint, and identifying a pareto-front of a solution space of the multiple objective functions using the numerical optimization algorithm. The method also includes selecting a data point from the pareto-front using a cost function, selecting a BHA design from the set of BHA designs using the selected data point, and building a BHA using the selected BHA design to be deployed downhole in a wellbore.

### CROSS-REFERENCE TO RELATED APPLICATIONS

This application claims the benefit of U.S. Provisional Patent Application Ser. No. 63/395,126 filed Aug. 4, 2022, the disclosure of which is incorporated herein by reference in its entirety.

### BACKGROUND

Embodiments described herein relate generally to downhole exploration and production efforts in the resource recovery industry and more particularly to techniques for bottom hole assembly configuration.

Downhole exploration and production efforts involve the deployment of a variety of sensors and tools. The sensors provide information about the downhole environment, for example, by collecting data about temperature, density, saturation, and resistivity, among many other parameters. This information can be used to control aspects of drilling and tools or systems located in the bottom hole assembly, along the drillstring, or on the surface. The sensors and tools may be implemented in a bottom hole assembly (BHA). For example, modern BHAs can include various components, such as drill bits, steering units, measuring while drilling (MWD) sensors, telemetry controllers, motors, stabilizers, and/or the like, including combinations and/or multiples thereof. One or more of these components may perform data acquisition and/or data processing. BHAs can also include mechanical couplings to link the various components.

### SUMMARY

An embodiment of a method of defining a BHA design includes performing a numerical optimization process, which includes applying a bottom hole assembly (BHA) design criterion using a numerical optimization algorithm to identify a set of BHA designs selected from a plurality of possible BHA designs, evaluating multiple objective functions for each BHA design of the set of BHA designs based at least in part on a modeling constraint, and identifying a pareto-front of a solution space of the multiple objective functions using the numerical optimization algorithm. The method also includes selecting a data point from the pareto-front using a cost function, selecting a BHA design from the set of BHA designs using the selected data point, and building a BHA using the selected BHA design to be deployed downhole in a wellbore.

An embodiment of a system includes a memory storing computer readable instructions, and a processing device for executing the computer readable instructions, the computer readable instructions controlling the processing device to perform operations. The operations include applying a bottom hole assembly (BHA) design criterion using a numerical optimization algorithm to identify a set of BHA designs selected from a plurality of possible BHA designs, evaluating multiple objective functions for each BHA design of the set of BHA designs based at least in part on a modeling constraint, identifying a pareto-front of a solution space of the multiple objective functions using the numerical optimization algorithm, selecting a data point from the pareto-front using a cost function, selecting a BHA design from the set of BHA designs using the selected data point, and building a BHA using the selected BHA design to be deployed downhole in a wellbore.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

Referring now to the drawings wherein like elements are numbered alike in the several figures:

FIG. 1 depicts a cross-sectional view of a wellbore operation system according to one or more embodiments described herein;

FIG. 2 depicts a block diagram of the processing system of FIG. 1, which can be used for implementing the present techniques herein according to one or more embodiments described herein;

FIG. 3 depicts a flow diagram of a method for automatically generating and evaluating BHA configurations according to one or more embodiments described herein;

FIG. 4A depicts a flow diagram of a method for automatically generating and evaluating BHA configurations according to one or more embodiments described herein;

FIG. 4B depicts a flow diagram of a method for normalization of objective function values and cost function calculation according to one or more embodiments described herein;

FIG. 5 illustrates examples of a BHA layout, BHA design criteria, and BHA designs according to one or more embodiments described;

FIG. 6 depicts an example of a multiple objective functions solution space according to one or more embodiments described herein;

FIGS. 7A and 7B depict graphs of the multiple objective functions solution space of FIG. 6 showing pareto-optimal data according to one or more embodiments described herein;

FIGS. 8A and 8B depict the solution space of FIGS. 7A and 7B using a weighting technique of the cost function according to one or more embodiments described herein; and

FIGS. 9A, 9B, and 9C depict examples of BHA designs according to one or more embodiments described herein.

### DETAILED DESCRIPTION

One or more embodiments described herein provide for automatically generating and evaluating BHA configurations considering one or more BHA design criteria, objective functions, and/or modeling constraints.

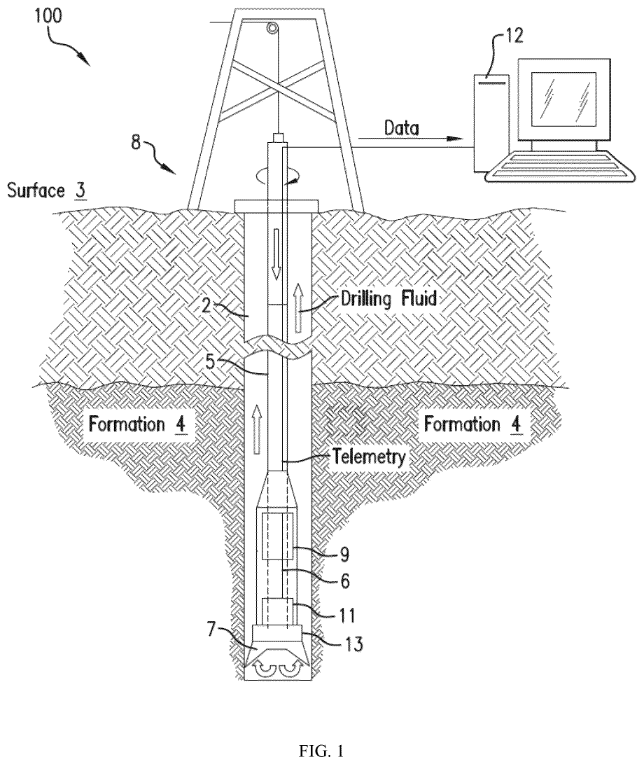

Wellbores are drilled into a subsurface to exploit hydrocarbons and for other purposes. In particular, FIG. 1 depicts a cross-sectional view of a wellbore operation system 100, according to aspects of the present disclosure. In traditional wellbore operations, logging-while-drilling (LWD) measurements are conducted during a drilling operation to determine formation rock and fluid properties of a formation 4. Those properties are then used for various purposes such as estimating reserves from saturation logs, defining completion setups, etc. as described herein.

The system and arrangement shown in FIG. 1 is one example to illustrate the downhole environment. While the system can operate in any subsurface environment, FIG. 1 shows a carrier 5 disposed in a borehole 2 penetrating the formation 4. The carrier 5 is disposed in the borehole 2 at a distal end of the borehole 2, as shown in FIG. 1.

As shown in FIG. 1, the carrier 5 is a drill string that includes a bottom hole assembly (BHA) 13. The BHA 13 includes a plurality of BHA components. The BHA 13 is a part of the operation system 100 and includes drill collars, stabilizers, reamers, and the like, and the drill bit 7. In examples, the drill bit 7 is disposed at a forward end of the BHA 13. The BHA 13 also includes sensors (e.g., measurement tools 11) and electronic components (e.g., downhole electronic components 9). The measurements collected by the measurement tools 11 can include measurements related to drill string operations, for example. BHA 13 also includes a steering tool configured to steer BHA 13 and drill bit 7 into a desired direction. The steering tool may receive steering commands based on which it creates steering forces to push or point drill bit 7 into the desired direction. Operation system 100 is configured to conduct drilling operations such as rotating the drill string and, thus, the drill bit 7. A drilling rig 8 also pumps drilling fluid through the drill string 5 in order to lubricate the drill bit 7 and flush cuttings from the borehole 2. The measurement tools 11 and downhole electronic components 9 are configured to perform one or more types of measurements in an embodiment known as logging-while-drilling (LWD) or measurement-while-drilling (MWD) according to one or more embodiments described herein.

Raw data is collected by the measurement tools 11 and transmitted to the downhole electronic components 9 for processing. The data can be transmitted between the measurement tools 11 and the downhole electronic components 9 by an electrical conduit 6, such as a wire (e.g., a powerline) or a wireless link, which transmits power and/or data between the measurement tools 11 and the downhole electronic components 9. Power is generated downhole by a turbine-generation combination (not shown), and communication to the surface 3 (e.g., to a processing system 12) is cable-less (e.g., using mud pulse telemetry, electromagnetic telemetry, etc.) and/or cable-bound (e.g., using a cable to the processing system 12, e.g.. by wired pipes). The data processed by the downhole electronic components 9 can then be telemetered to the surface 3 for additional processing or display by the processing system 12.

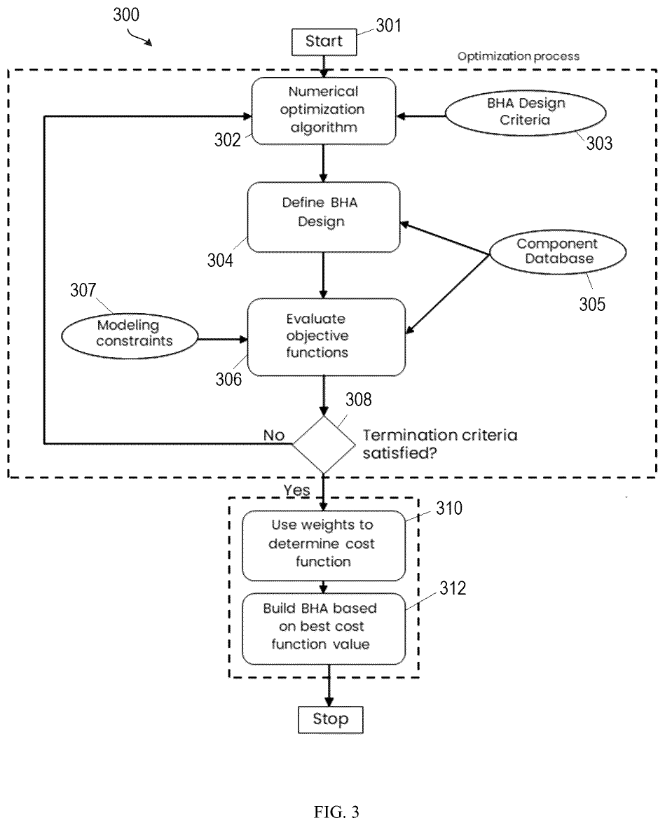

Drilling control signals can be generated by the processing system 12 (e.g., based on the raw data collected by the measurement tools 11) and conveyed downhole or can be generated within the downhole electronic components 9 or by a combination of the two according to embodiments of the present disclosure. The downhole electronic components 9 and the processing system 12 can each include one or more processors and one or more memory devices, which can include any suitable device for storing data. In alternate embodiments, computing resources such as the downhole electronic components 9, sensors, and other tools can be located along the carrier 5 rather than being located in the BHA 13, for example. The borehole 2 can be vertical as shown or can be in other orientations/arrangements (see, e.g., FIG. 3A, FIG. 3B).

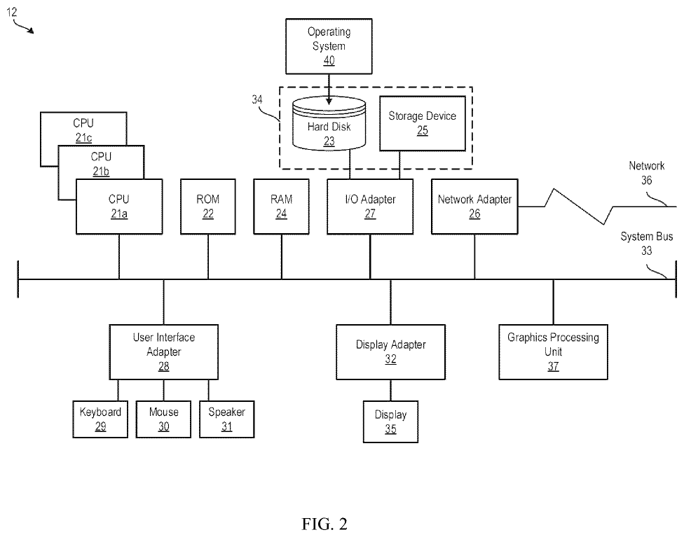

It is to be understood that embodiments of the present disclosure are capable of being implemented in conjunction with any other suitable type of computing environment now known or later developed. For example, FIG. 2 depicts a block diagram of the processing system 12 of FIG. 1, which can be used for implementing the techniques described herein. In examples, processing system 12 has one or more central processing units 21a, 21b, 21c, etc. (collectively or generically referred to as processor(s) 21 and/or as processing device(s) 21). In aspects of the present disclosure, each processor 21 can include a reduced instruction set computer (RISC) microprocessor. Processors 21 are coupled to system memory (e.g., random access memory (RAM) 24) and various other components via a system bus 33. Read only memory (ROM) 22 is coupled to system bus 33 and can include a basic input/output system (BIOS), which controls certain basic functions of processing system 12.

Further illustrated are an input/output (I/O) adapter 27 and a network adapter 26 coupled to system bus 33. I/O adapter 27 can be a small computer system interface (SCSI) adapter that communicates with a memory, such as a hard disk 23 and/or a tape storage device 25 or any other similar component. I/O adapter 27 and memory, such as hard disk 23 and tape storage device 25 are collectively referred to herein as mass storage 34. Operating system 40 for execution on the processing system 12 can be stored in mass storage 34. The network adapter 26 interconnects system bus 33 with an outside network 36 enabling processing system 12 to communicate with other systems.

A display (e.g., a display monitor) 35 is connected to system bus 33 by display adaptor 32, which can include a graphics adapter to improve the performance of graphics intensive applications and a video controller. In one aspect of the present disclosure, adapters 26, 27, and/or 32 can be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 can be interconnected to system bus 33 via user interface adapter 28, which can include, for example, a Super I/O chip integrating multiple device adapters into a single integrated circuit.

In some aspects of the present disclosure, processing system 12 includes a graphics processing unit 37. Graphics processing unit 37 is a specialized electronic circuit designed to manipulate and alter memory to accelerate the creation of images in a frame buffer intended for output to a display. In general, graphics processing unit 37 is very efficient at manipulating computer graphics and image processing and has a highly parallel structure that makes it more effective than general-purpose CPUs for algorithms where processing of large blocks of data is done in parallel.

Thus, as configured herein, processing system 12 includes processing capability in the form of processors 21, storage capability including system memory (e.g., RAM 24 and mass storage 34), input means such as keyboard 29 and mouse 30, and output capability including speaker 31 and display 35. In some aspects of the present disclosure, a portion of system memory (e.g., RAM 24 and mass storage 34) collectively store an operating system to coordinate the functions of the various components shown in processing system 12.

According to one or more embodiments described herein, techniques for evaluating BHA configurations of a BHA, such as the BHA 13, are provided. Modern BHAs can include various components, such as drill bits, steering units, measuring while drilling (MWD) assembly, Formation Evaluation tools (FE tools), telemetry controllers, motors, stabilizers, and/or the like, including combinations and/or multiples thereof. BHAs can also include mechanical couplings to link the various components. Because of the multitude of different components, many different BHA configurations (also referred to as “BHA designs”) are possible, with each different BHA configuration having certain benefits and drawbacks. For example, one BHA configuration may operate more efficiently in certain formation types while another BHA configuration may operate more efficiently in other formation types.

The positioning of components (e.g., tools; subs, such as stabilizer subs and flex subs; and/or the like, including combinations and/or multiples thereof) within the BHA effects mechanical properties like bending moment distribution and/or high frequency torsional oscillation (HFTO) susceptibility, functional properties like sensor offsets, and/or economical properties due to the number of components.

Because of the many different BHA configuration possibilities (e.g., type, number, and order of components of the BHA), it is difficult to determine an optimal BHA configuration. Manual iteration through the many different BHA configurations is laborious and highly dependent on the experience and heuristics of the evaluators. The number of different BHA configurations can be in the tens or hundreds of thousands of different possibilities. Finding the optimal BHA configuration with this high number of possible variants manually can be very laborious and time consuming, without the assurance of an optimal solution being found. Additionally, a specific region or geometric market may impose specific restrictions on the BHA design, which result in significant effort of evaluating BHA designs.

To address these and other shortcomings of conventional approaches to determining BHA configurations, one or more embodiments described herein can automate the calculation and evaluation of an iterative process for identifying an optimal BHA configuration. One or more embodiments described herein provide a numerical optimization technique used to generate multiple BHA configurations and to evaluate those BHA configurations to determine an optimal BHA configuration and/or a set of optimal BHA configurations. As an example, one or more embodiments provide for automatically generating and evaluating BHA configurations considering one or more BHA design criteria, objective functions, and/or modeling constraints. Once evaluated, an optimal BHA configuration (or a set of optimal BHA configurations) can be selected from the various BHA configurations based on a cost function value. That is, a multi-objective optimization process of several or multiple objective functions is performed first using BHA design criteria, then after the optimization, a weighting technique and a decision of which BHA design is optimal are performed. This yields a solution space exploration of the optimization algorithm. Optimizing an objective function refers to finding a BHA design that leads to a solution of the objective function that is close or closest to the associated objective of the objective function. In an embodiment, an objective may be a maximal dog leg severity a BHA design can withstand. Optimizing the objective function for the dog leg severity refers to finding an optimal BHA design that allows the greatest dog leg severity among all evaluated BHA designs.

An object function may be related to a static mechanical objective, like the maximal dogleg severity the BHA can withstand, dynamic objectives like the frequency of HFTOs, and/or economic objectives like overall cost of the BHA or the service or length of the BHA. One or more embodiments uses a component database and tool slots to assign respective tools to the BHA automatically. Initially, the positioning and quantity of tools or additional components (e.g., tools; subs, such as stabilizer subs and flex subs; and/or the like, including combinations and/or multiples thereof) is not restricted in some embodiments. To enhance performance, one or more embodiments take into account design/configuration restrictions, like positioning the bit at the bottom of the BHA, positioning a steering unit directly above the bit, and so on. A numerical optimization algorithm is used to define the BHA designs and efficiently sample through a solution space to identify optimal designs/configurations depending on desired use cases for the BHA.

Particularly, one or more embodiments described herein enhance optimization of a sampling space. A discrete parameter space describes the permutations of tool positioning and quantity in the BHA. While the goal is to cover a large solution space, the results in this solution space should satisfy functional constraints, such as logical order of components, component compatibility, service requirements, and/or the like, including combinations and/or multiples thereof. Allowed permutations of tool positioning in the BHA result in a large and partitioned discrete solution space. A full-set parameter space can be covered to find a global optimum due to constraints in the multi-objective optimization. According to one or more embodiments described herein, a multi-objective optimization is combined with constraint handling while providing for a robust yet efficient solution space exploration.

According to one or more embodiments described herein, a BHA design criterion (e.g., order of tools, which tools are required/optional, etc.) can be applied to a numerical optimization algorithm to define BHA configurations using a component database, which indicates what tools are available and their associated properties. Examples of component properties include component dimensions (length, inner and outer diameter), material properties, magnetic properties, type of component (MWD, FE tool, stabilizer, flex sub, vibration damping device), operational limits (maximum bending moment, maximum axial load (weight on bit), maximum torque, maximum oscillating torsional load (torsional vibration)). According to one or more embodiments described herein, rather than providing a singular optimal BHA configuration, a set of best compromises of the objectives (referred to as “pareto solutions” or a “pareto-front”) can be provided as determined by the numerical optimization algorithm using evaluation results (solutions) of the multiple objective functions, and then a BHA can be selected from this set based on a cost function.

The evaluation of an objective function includes evaluating (calculating or simulating) a solution or value of a respective objective function for a BHA design. The numerical optimization algorithm is used to iteratively find an optimal BHA design. Starting with an initial BHA design, the numerical optimization algorithm modifies the initial BHA design in a manner that the evaluation of multiple objective functions results in solutions for the modified BHA design that provide a better compromise related to the multiple objectives associated with the multiple objective functions. An initial BHA design may be defined by the numerical optimization algorithm. Alternatively, a predefined initial BHA design may be provided to the numerical optimization algorithm. In each iteration of the numerical optimization process, the numerical optimization algorithm uses evaluated solutions (values) of the multiple objective functions of a BHA design (e.g., initial BHA design) used in a previous iteration step (previous evaluation) and determines a modified BHA design (or optimized BHA design) that provides improved (or optimized) solutions (values) of the multiple objective functions for the modified BHA design. In a subsequent iteration step, the evaluated solutions (values) of the modified BHA design are used by the numerical optimization algorithm to determine a further modified BHA design that provides even more improved solutions (values) of the multiple objective functions of the further modified BHA design, and so on.

The iterative numerical optimization process is configured to converge with increasing number of iterations. The solutions of a plurality of iterations (e.g., j iterations) form a solution space (e.g., j solutions in the solution space). The solutions of the objective functions resulting from one iteration form one data point in the solution space. That is, one data point represents the multiple solutions of the evaluation of the multiple objective functions from one iteration. The dimension of the solution space depend on the number of objective functions used in the evaluation step of the numerical optimization process. That is, m objective functions result in a m-dimensional solution space. The numerical optimization algorithm determines the pareto-front in the solution space. The data points in the solution space that make-up the pareto-front represent BHA designs that are best compromises for achieving the multiple objectives. A weighted cost function may be used to find the best solution among the data points in the pareto-front.

Turning now to FIG. 3, a flow diagram of a method 300 for automatically generating and evaluating BHA configurations is shown according to one or more embodiments described herein. The method 300 can be performed by any suitable controller, device, and/or system, such as the processing system 12 of FIGS. 1 and 2.

The method 300 provides for using a numerical multi-objective optimization algorithm (e.g., a nondominated sorting genetic algorithm (NSGA-II), a global pattern search algorithm, a multi-objective evolutionary algorithm, a multi-objective genetic algorithm, a multi-objective simulated annealing, a neural network, or a machine learning algorithm (AI)), which efficiently samples through a solution space to identify an optimal solution and/or an optimal set of solutions. As several objectives can have opposing optimal values, the optimal set of solutions defines a set of best compromises of the objectives—the pareto solutions. The method 300 also provides for the automatic generation and evaluation of BHA designs to provide a comprehensive consideration of the possible solution space. To do this, a constraint-based definition of the BHA design is implemented. The combination of numerical optimization with constraints enables an efficient and simultaneously broad solution space exploration.

The method 300 begins at block 301, and at block 302, a numerical optimization algorithm is implemented. The numerical optimization algorithm at block 302 (also referred to as a numerical multi-objective optimization algorithm) can be the nondominated sorting genetic algorithm (NSGA-II) or another suitable numerical multi-objective optimization algorithm. BHA design criteria 303 (i.e., one criterion or multiple criteria) are applied to a numerical optimization process using the numerical optimization algorithm at block 302. The BHA design criteria 303 define how the numerical optimization algorithm at block 302 configures BHA designs.

For example, a BHA design criterion of the criteria 303 might define that a first (lowest) component in the BHA is a drill bit, that a second (next lowest) component in the BHA is a steering unit, that a third (next lowest) component in the BHA is an MWD assembly, and that a fourth (next lowest) component in the BHA is a telemetry tool in this exact order, while other components can be added thereafter until a final component of a heavy weight drill pipe (HWDP) is added as the last component. Thus, the BHA design criteria 303 set a baseline of design limitations on the BHA, which significantly reduces the solution space. In this way, the BHA design criteria 303 act as a course filter to eliminate undesirable BHA designs.

An example of a BHA design criterion of the criteria 303 is that the BHA design should include an anti-vibration and stick slip (Anti-VSS) component (such as a vibration damping device) and a motor, but their position is not otherwise restricted. Another example of the BHA design criterion of the criteria 303 is that the motor should come above the vibration damping device component. This allows for multiple designs to be defined such that the specified components from the BHA design criteria are included in the BHA but other additional components (e.g., tools and subs) are optional in their inclusion, quantity, position, and/or the like. The term “above” in this application refers to a position in the BHA that is closer to the earth surface (as measured along an axis of a borehole), and the term “below” refers to a position closer to the bottom of the borehole or the drill bit (as measured along an axis of a borehole). A vibration damping tool that may be used in one or more embodiments is described in patent U.S. Pat. No. 11,136,834, entitled “Dampers for mitigation of downhole tool vibrations”, which is hereby incorporated by reference in its entirety.

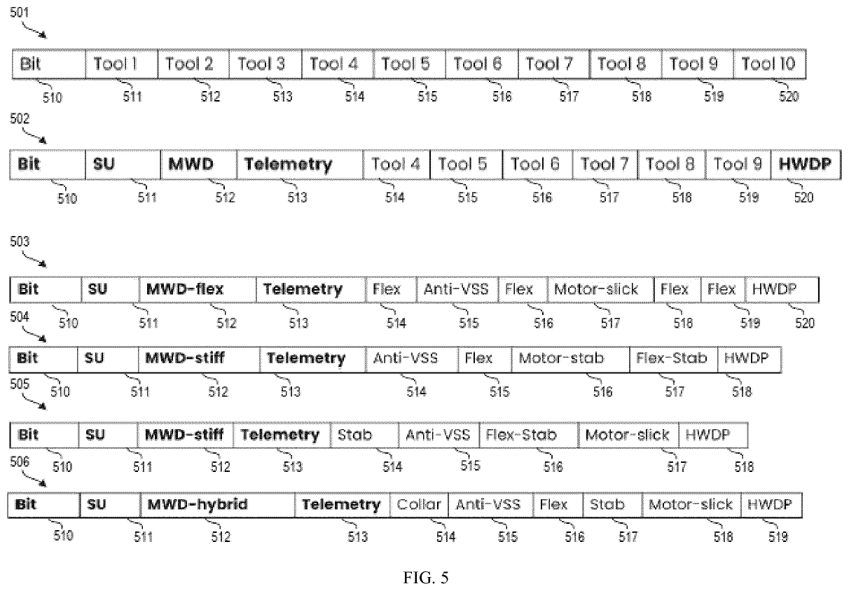

Applying the BHA design criteria 303 to a numerical optimization process using the numerical optimization algorithm at block 302 results in a defined BHA design at block 304. The BHA design at block 304 identifies a set of BHA designs selected from a plurality of possible BHA designs. The set of BHA designs selected from the plurality of possible BHA designs do not include BHA designs that are not within the defined BHA design criteria. That is, BHA designs that do not satisfy the BHA design criteria are filtered out from the plurality of possible BHA designs. The BHA design at block 304 can implement one or more components from a component database 305, which provides a set of available components (e.g., tools and subs) and properties associated with each of the available components (e.g., quantity, model, operating specifications/limits, size, and/or the like, including combinations and/or multiples thereof). Examples of BHA designs as generated at block 304 are described further herein with reference to FIG. 5.

With continuing reference to FIG. 3, at block 306, multiple objective functions for each BHA design of the set of BHA designs are defined and evaluated. According to an embodiment, the multiple objective functions can be evaluated based on modeling constraints 307. The evaluation of the multiple objective functions may comprise simulations (e.g., formation evaluation simulations, torsional oscillations, and/or bending moment oscillations). The multiple objective functions can be based on one or more of the following: a minimum overall BHA length, a maximum overall BHA length, a target overall BHA length, a maximal dogleg severity of the BHA, a maximal angular amplitude of a high frequency torsional oscillation of a component of a vibration damping device, a minimum distance of functional elements, a maximum distance of functional elements (e.g., sensor distance to bit, or distance between two specific tools within the BHA), a target distance of functional elements, a maximum BHA stiffness, a specified BHA stiffness, a minimal local vibration amplitude within the BHA per vibration type (axial, lateral, torsional), a maximum specified vibration severity within the BHA per vibration type, a maximum allowed acidity of the drilling fluid (e.g. corrosion effects), a maximum allowed flow rate of the drilling fluid, a maximum build-up rate (inclination build-up), a minimal local magnetic interference, a minimum electrical power consumption, and a maximum electrical power consumption margin (difference between maximum available electrical power and consumed electrical power). Magnetic interference refers to a magnetic field at a specific location in the BHA. The magnetic field may be caused by a magnetic formation material surrounding the wellbore, or may be caused by a portion of the BHA containing magnetic material, such as magnetic steel. A magnetic interference at a location in the BHA that includes a device configured to detect a magnetic field (e.g., a magnetometer), such as the earth magnetic field, may cause measurement failures. A minimum or maximum electrical power refers to electrical power required by electronic devices included in the BHA, such as amplifiers, processors, sensors, or motors.

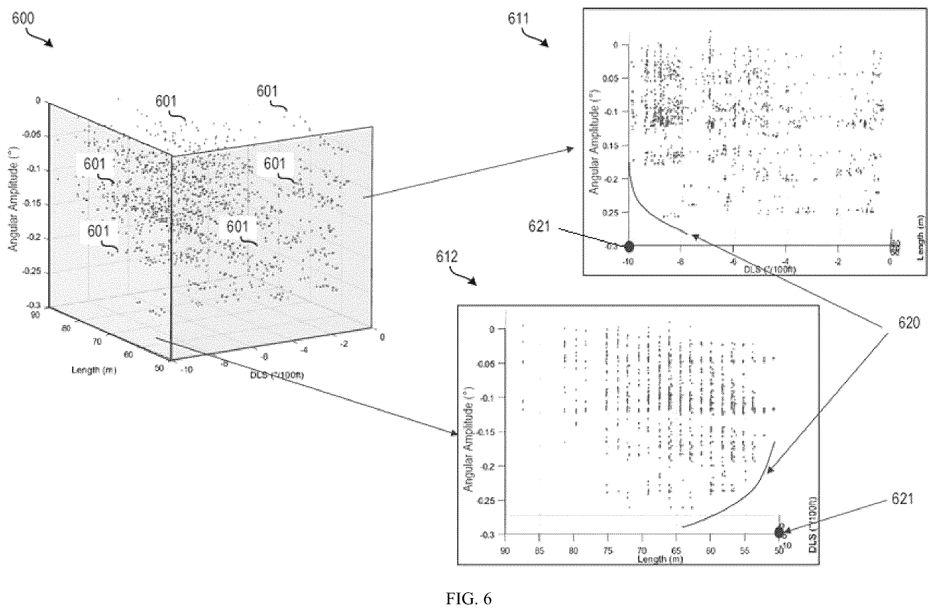

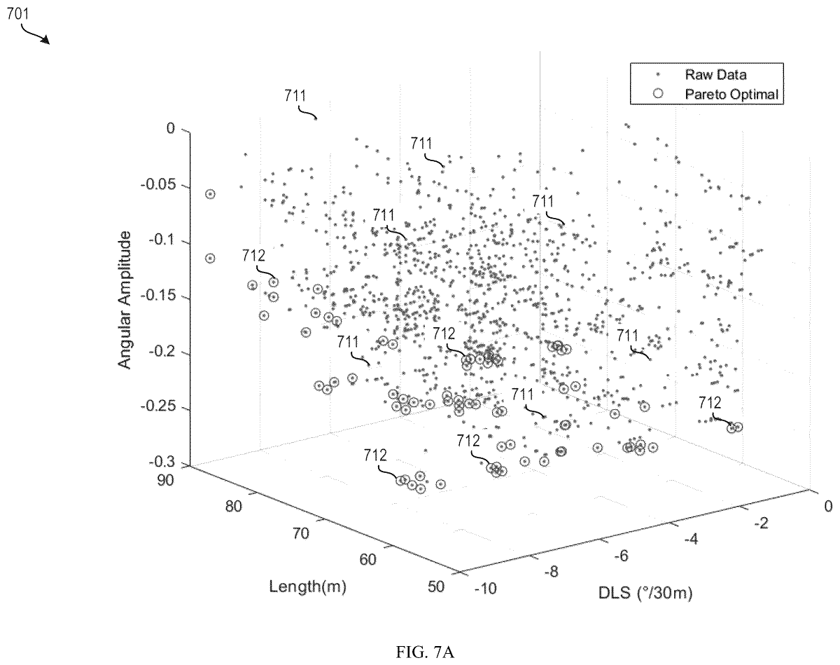

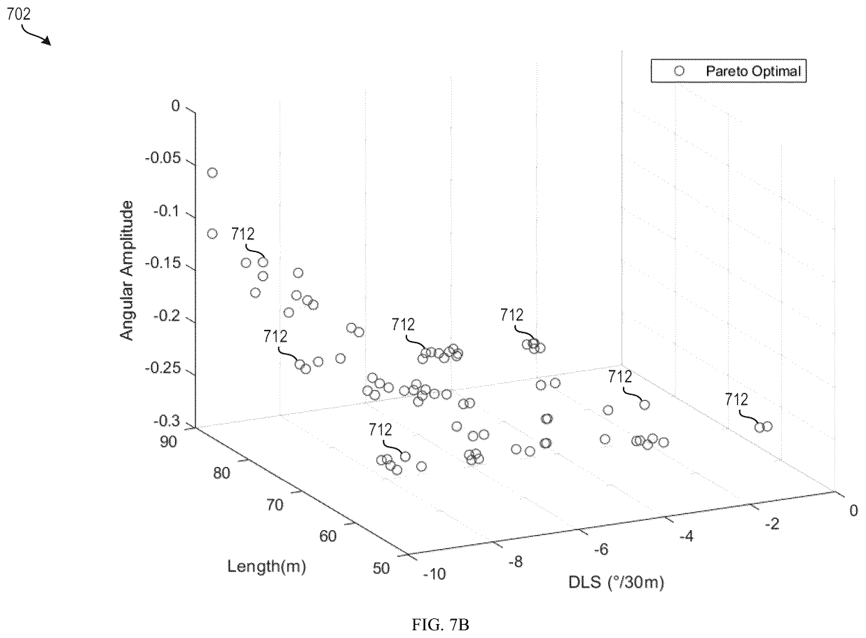

The modeling constraints 307 define certain constraints regarding the definition of the physical models of the components that are the basis for the calculation. For example, a modeling constraint can be the maximal bending moment that a specific component can withstand, such as an operational limit of bending moment a specific component is specified for. Performing block 306 results in a solution being added to a solution space of the multiple objective functions, which is described further herein with reference to FIGS. 6, 7A and 7B, for example. The angular amplitude in the BHA or at a component of the vibration damping device may be detected by using a sensor, including a magnetometer, or an accelerometer.

With continuing reference to FIG. 3, at decision block 308, it is determined whether a termination criterion is satisfied. The termination criterion (or criteria) may be a maximum number of BHA designs to generate and evaluate, whether an optimal solution has already been found, a maximum amount of time spent generating and evaluating BHA designs, a threshold difference between two solutions in the solution space (e.g. absolute value difference or percentage difference), a threshold difference to a theoretical best data point in the solution space, and/or the like, including combinations and/or multiples thereof. If it is determined that the termination criterion has not been satisfied at decision block 308, the method 300 returns to block 302 and repeats.

Each repetition of the blocks 302, 304, 306 results in one solution (e.g., solution of the multiple objective functions for a BHA design variant) being added to the solution space. If, however, it is determined that the termination criterion has been satisfied at decision block 308, the method 300 proceeds to block 310. Once the termination criterion is satisfied at decision block 308, the solution space of the multiple objective functions is established.

The optimization process may be terminated when the optimization process converges. This is, the optimization process converges when the change between solutions of the multiple objective functions of two subsequent iterations of the numerical optimization process (loop from step 302-308 and back to 302) is less than a selected difference (e.g., the change is smaller than 5%, 1%, 0.5%, or 0.1%). In some embodiments, the optimization process will be terminated when a predetermined number of BHAs are evaluated. For example, the optimization process may terminate after evaluation of 500 BHAs, 1000 BHA, 3000 BHAs, 10,000 BHAs, or 20,000 BHAs. In other embodiments, the optimization process is terminated after a predetermined optimization time interval. The time interval may be 1 hour, 5 hours, 10 hours, 24 hours, or any other desired interval. The predetermined optimization interval may be independent of how many iterations may have been performed or whether the optimization process converges or not.

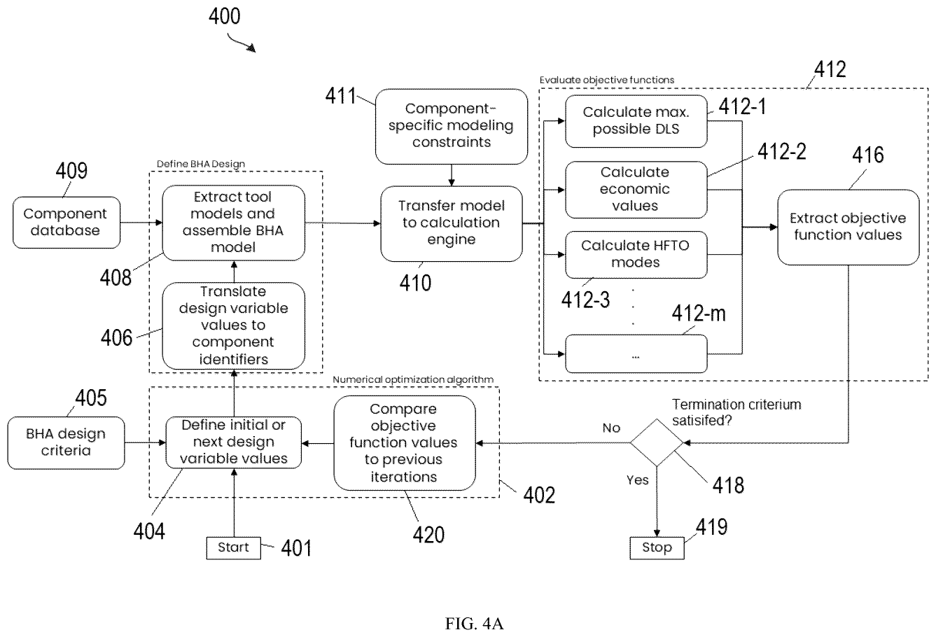

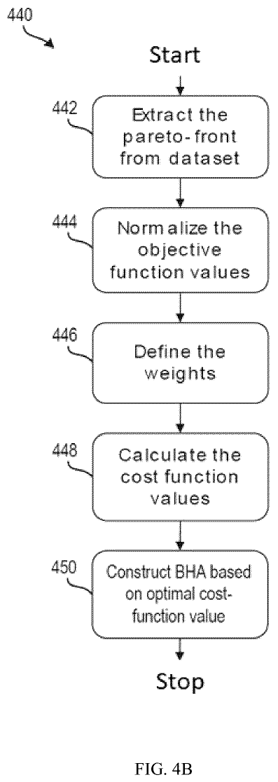

At block 310, weights are applied to the solutions in the solution space of the objective function (after the optimization is performed at blocks 302, 304, 306) to determine a cost function. According to one or more embodiments described herein, the data of the solution space can be normalized before determining the cost function. Performing block 310 is described further herein with reference to FIG. 4B, for example. This results in a selected design for building the BHA.

With continued reference to FIG. 3, at block 312, a BHA can be constructed and implemented (e.g., deployed downhole in a wellbore) based on results of the cost function analysis at block 310, namely the selected design. As an example, the BHA can be constructed having the selected design and then deployed in a wellbore, such as a wellbore of a hydrocarbon recovery operation (such as a drilling, or re-entry operation), a geothermal operation, a completions operation, and/or the like, including combinations and/or multiples thereof.

Additional processes also may be included, and it should be understood that the process depicted in FIG. 3 represents an illustration, and that other processes may be added or existing processes may be removed, modified, or rearranged without departing from the scope of the present disclosure. Other processes may be filtering processes, data storing processes, or the creation of a BHA component with properties that optimizes an objective to create a component that may not be available in the database.

FIG. 4A depicts a flow diagram of a method 400 for automatically generating and evaluating BHA configurations according to one or more embodiments described herein. The method 400 can be performed by any suitable controller, device, and/or system, such as the processing system 12 of FIGS. 1 and 2.

The method 400 begins at block 401, and at block 402, a numerical optimization algorithm (e.g., the numerical optimization algorithm at block 302 of FIG. 3) is implemented. At block 404, design variable values (an initial set of design variables, or a next set of design variables based on a previous iteration) are defined based on BHA design criteria 405 (e.g., the BHA design criteria 303). The design variable values are examples of the BHA design criteria 303. At block 406, the design variable values are translated to component identifiers. At block 408, component models are extracted and a BHA design is assembled based on the design variable values from block 406 and a component database 409 (e.g., the component database 305 of FIG. 3). Assembling the BHA model (e.g., a BHA design) at block 408 is substantially similar to defining the BHA design at block 304 of FIG. 3.

At block 410, the BHA model is sent, from a BHA design engine (not shown) to a calculation engine (not shown) of the processing system 12 to perform evaluations (see, e.g., block 306 of FIG. 3). Component-specific modeling constraints from block 411 can also be sent at block 410. At block 412, the BHA model is evaluated using evaluations of the multiple objective functions. For example, the evaluation at block 412 can include evaluating a dogleg severity for the BHA design (block 412-1), evaluating economic values (e.g., cost, lifetime estimation, hydrocarbon production estimates, etc.) of the BHA design (block 412-2), evaluating HTFO modes (block 412-3), and/or the like, including combinations and/or multiples thereof. It should be appreciated that the particular evaluations shown in block 412 (e.g., the evaluations of blocks 412-1-412-3) are merely examples and evaluations of other objective functions, such as an evaluation at block 412-m, can be implemented additionally and/or instead.

At block 416, objective function values are extracted from the evaluation results from block 412-1-412-m. At block 418, it is determined whether a termination criterion is satisfied (see, e.g., block 308 of FIG. 3). If the termination criterion is satisfied, the method 400 terminates at block 419.

However, if the termination criterion is not satisfied at block 418, the method 400 returns to block 402, and at block 420, the objective function values are compared to previous iterations (e.g., previous iterations of the blocks 402-416). Based on the result of the comparison of the objective function values with the objective function values of the previous iteration, the BHA design is modified (block 404) to improve the BHA design towards a BHA design that better meets the objectives related to the multiple objective functions. Blocks 402-416 and 420 are repeated until the termination criterion (see, e.g., block 308 of FIG. 3) is satisfied as determined at block 418, at which point the method 400 ends.

Additional processes also may be included, and it should be understood that the process depicted in FIG. 4A represents an illustration, and that other processes may be added (as mentioned earlier) or existing processes may be removed, modified, or rearranged without departing from the scope of the present disclosure.

FIG. 4B depicts a flow diagram of a method 440 for cost function analysis and objective function normalization according to one or more embodiments described herein. The method 440 can be performed by any suitable controller, device, and/or system, such as the processing system 12 of FIGS. 1 and 2. As an example, the method 440 can begin once the termination criterion is satisfied at block 420 of FIG. 4A, where a dataset of possible solutions (e.g., the set of BHA designs) has been determined. The method 440 also further details the cost function steps 310 and 312 depicted in FIG. 3.

At block 442, a pareto-front is extracted from the dataset of possible solutions (also named data points or values) in the solution space of the multiple objective functions. FIG. 6A, described in more detail herein, shows an example of a pareto-front (see, e.g., pareto-front 620). With continued reference to FIG. 4B, at block 444, the data points in the solution space of the multiple objective functions are normalized. The data points in the solution space of the multiple objective functions can then be evaluated. For example, normalizing the data points of the solution space or the pareto-front based on the largest value of the data points in the solution space or pareto-front, the following equation can be used:

$${f}_{n k} ( x ) = - \frac{{f}_{k} ( x ) - max ( {f}_{k} ( x ) )}{max ( {f}_{k} ( x ) ) - min ( {f}_{k} ( x ) )} , \qquad ( Eq . 1 )$$

and for normalizing the data points of the solution space or the pareto-front based on the smallest value of the data point in the solution space or pareto-front, the following equation can be used:

$${f}_{n k} ( x ) = - \frac{{f}_{k} ( x ) - min ( {f}_{k} ( x ) )}{max ( {f}_{k} ( x ) ) - min ( {f}_{k} ( x ) )} , \qquad ( Eq . 2 )$$

where ƒ is an objective function, k represents a specific objective function and is a value [1 . . . m], m is a number of objective functions of the multiple objective functions, n is a normalized objective function, and x is a design variable value.

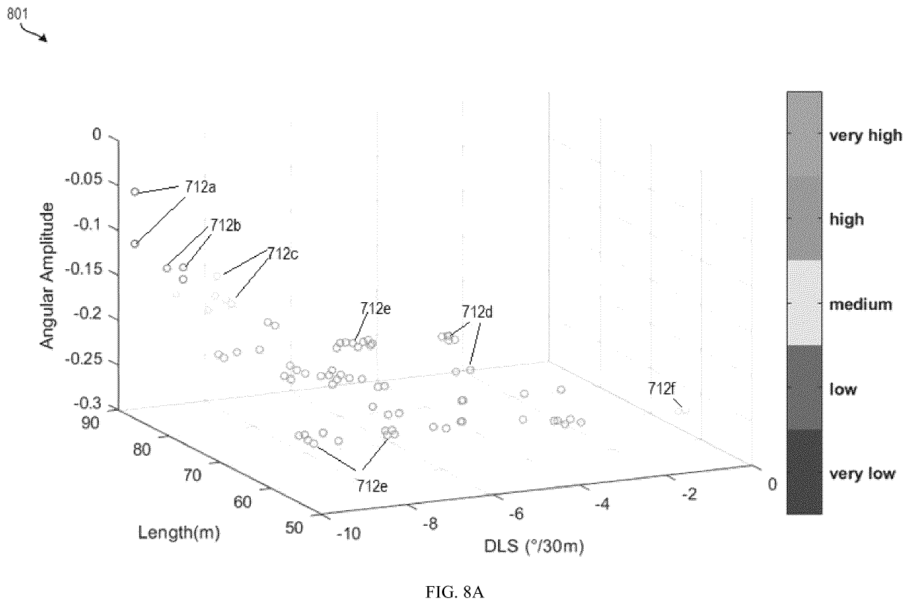

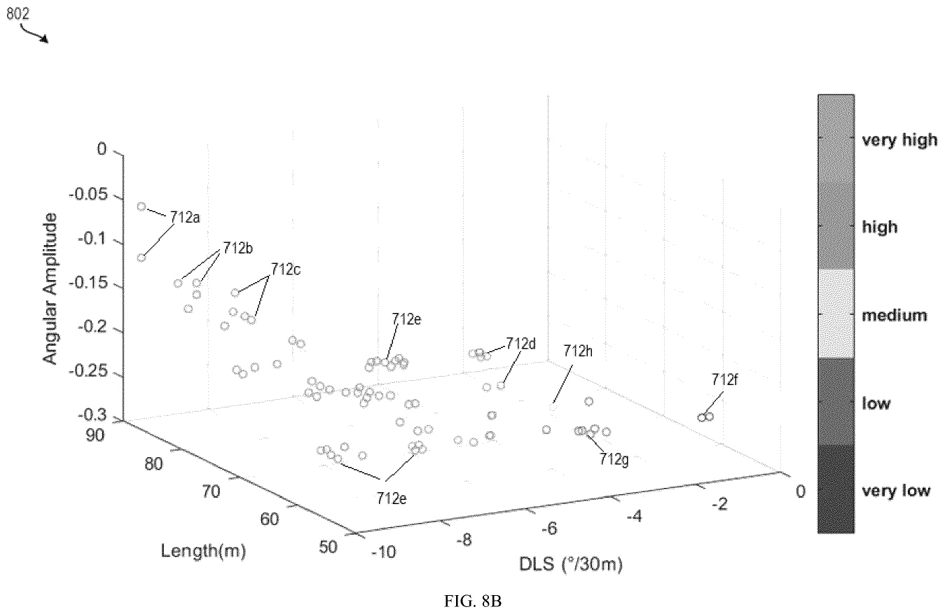

At block 446, weights are defined. One or more techniques for weighting the values of the solution space of the multiple objective functions are further described herein with reference to FIGS. 8A and 8B. With continued reference to FIG. 4B, at block 448, the cost function values are calculated. As an example, the cost function values can be calculated using the following equation:

$$costf ( x ) = {c}_{1} \cdot {f}_{n 1} ( x ) + {c}_{2} \cdot {f}_{n 2} ( x ) + … + {c}_{m} \cdot {f}_{nm} ( x ) , \qquad ( Eq . 3 )$$

where costƒ is the cost function, k is a value [1 . . . m], m is the number of objection functions, n is a normalized objective function, c is a weight, and x is a design variable value. At block 450, the BHA design is constructed based on an optimal cost function value. The weighting may be applied to the normalized or unnormalized values of the solution space of the objective function.

Additional processes also may be included, and it should be understood that the process depicted in FIG. 4B represents an illustration, and that other processes may be added (as mentioned earlier) or existing processes may be removed, modified, or rearranged without departing from the scope of the present disclosure.

FIG. 5 depicts examples of a BHA layout 501, one or more BHA design criteria 502, and BHA designs 503, 504, 505, 506 according to one or more embodiments described herein. The BHA layout 501 includes a bit 510 (e.g., the drill bit 7) and ten possible slots 511-520 (or “positions”) for components within the BHA.

The BHA design criteria 502 establishes certain restrictions or requirements for designing the BHA. One example of the BHA design criterion 502 is as follows: the slot 511 is occupied by a steering unit (SU), the slot 512 is occupied by a MWD assembly, the third slot 513 is occupied by a telemetry tool, and the last slot (e.g., slot 520) is a heavy weight drill pipe (HWDP). Another example of the BHA design criterion 502 is that the BHA should include a vibration damping device and a motor, but their position is not restricted. A further example of the BHA design criterion 502 is that the BHA should include a vibration damping device and a motor that always comes above the vibration damping device, but their position is not otherwise restricted. The remaining slots 514-520 are open, and one or more additional components can be added and associated with those slots. It should be appreciated that only the specified tools from the BHA design criteria 502 must be in the BHA designs (see block 304 of FIG. 3). Other additional components are optional in their inclusion, quantity, position, and/or the like, including combinations and/or multiples thereof. These components can be selected from the component database 305 and/or the component database 409 (FIG. 4A).

A component database (e.g., component database 305 and/or 405) can include the available components and their associated properties as described herein. An example of components that may be included in the component database are a steering unit, a MWD assembly (which could include a flexible MWD assembly, a stiff MWD assembly, and/or a hybrid MWD assembly), a telemetry tool, a vibration damping device, a motor, a stabilizer sub, a flexible stabilizer sub, a drill collar, and a flex collar. It should be appreciated that these examples of components are provided merely for illustrative purposes and are not intended to limit the embodiments described herein. Given these components and the example restrictions defined by the BHA design criteria 502, there exist nearly 100,000 different possible combinations of BHA designs.

The method 300 and/or the method 400 can be performed using the BHA layout 501, the BHA design criteria 502, and the component database to generate a set of BHA designs that is a best compromise of the objectives. Four examples of such BHA designs are shown in FIG. 5 as BHA designs 503, 504, 505, 506. In these examples, the BHA designs 503-506 can be created under consideration of the modeling constraints 307 and seek to achieve objectives, such as maximize dogleg severity capability of the BHA, minimizing the BHA length, and maximizing the angular amplitude. In other examples, other modeling constraints 307 are possible.

FIG. 6 depicts an example of an objective function solution space 600 according to one or more embodiments described herein. The objective function solution space 600 is generated, for example, at block 306 of the method 300, through multiple BHA design iterations (e.g., multiple iterations of blocks 302, 304, 306). The objective function solution space 600 is represented as a graph that plots solutions of the objective functions for individual BHA designs as raw data 601 in three-dimensions (such as three objective functions). One dimension is length of BHA (in meters), another dimension is dogleg severity (in degrees per 30 meters), and a third dimension is angular amplitude. The raw data 601 represents values of the objective functions for a set of BHA designs selected from a plurality of possible BHA designs.

The objective function solution space 600 can be viewed in part in two dimensions (considering only two objective functions) as shown by the graphs 611, 612. Particularly, the graph 611 plots dogleg severity versus angular amplitude, and the graph 612 plots BHA length against angular amplitude. The curves 620 of each of the graphs 611, 612 represents a pareto-front, which are the best compromises between the plotted objectives. For example, the pareto-front 620 of the graph 611 represents the best compromises between dogleg severity and angular amplitude. Similarly, the pareto-front 620 of the graph 611 represents the best compromises between BHA length and angular amplitude. The raw data points 601 closer to the pareto-front 620 are more ideal compromises for selected BHA designs than other compromises for selected BHA designs farther from the pareto-front 620. The point 621 represents a theoretical best possible data point. The theoretical best possible data point fully meets the objectives. The objectives are either technically best objectives (e.g.. large allowed dog leg, smallest angular amplitude, shortest BHA length) or are otherwise defined best objectives, such as a specific dog leg, a specific angular amplitude, a specific BHA length, considering specific BHA design or operational limitations.

FIGS. 7A and 7B depict graphs 701, 702 of a multi-objective function solution space according to one or more embodiments described herein. Particularly, FIG. 7A depicts a graph 701 of data points of the solution space of the multi-objective function. The solution pace includes raw data points 711 and pareto-optimal data points 712, while FIG. 7B depicts a graph 702 of only the pareto-optimal data points 712 without the raw data points 711. The pareto-optimal data points 712 are closest to the theoretical best possible data point and form the pareto-front. The raw data points 711 are the remaining data points in the solution space of the multi-objective function solution space, which do not meet the condition of being closest to the theoretical best possible data point.

In each of FIGS. 7A and 7B, the graphs 701, 702 plot the raw data points 711 and/or the pareto-optimal data points 712 (also referred to as pareto-front or pareto solutions) in three-dimensions: length of BHA (in meters), dogleg severity (in degrees per 30 meters BHA length), and angular amplitude. The raw data points 711 represent solutions of the objective functions for a set of BHA designs selected from a plurality of possible BHA designs. The pareto-optimal data points 712 represent a subset of the solutions of the objective functions for the set of BHA designs.

FIGS. 8A and 8B depict the multiple objective functions solution space of FIGS. 7A and 7B using a weighting technique according to one or more embodiments described herein. In particularly, FIG. 8A depicts a graph 801 of the solution space including only the pareto-optimal data points where each objective (e.g., dogleg severity, length, and angular amplitude) is weighted similarly. In contrast, FIG. 8B depicts a graph 802 of the solution space including only the pareto-optimal data points where the dogleg severity objective is a highest weighted objective (prioritized objective) relative to the other objectives represented in the multiple objective functions solution space, such as the length and angular amplitude objectives. Consequently, the weighting technique classifies solutions in the solution space or pareto-front with smaller dog leg severity lower (reddish colors). The weighting technique prioritize solutions in the solution space or pareto-front with greater dog leg severity. Each of the circles of the graphs 801, 802 represent pareto-optimal data (e.g., the pareto-optimal data 712 of FIGS. 7A and 7B). As is evident from the graphs 801, 802, each of the pareto-optimal data points is classified on a scale where a lower rating (e.g., reddish colors) indicates a less optimal solution and where a higher rating (e.g., greenish colors) indicates a more optimal solution. The theoretical most optimal solution of the objective function would be a great dogleg, a short length, and a small angular amplitude (represented by the corner of the coordinate system closest to the front of the page). Different types of scales having various gradations can be used to classify the pareto-optimal solutions.

In the example of FIGS. 8A and 8B, the pareto-optimal data are classified as being “very low,” “low,” “medium,” “high,” or “very high” which indicates how suitable each the particular pareto-optimal solutions are (e.g., a “very high” solution is more preferable, based on the weighting, than a “high” (or lower) classification). For example, the pareto-optimal data points 712 are weighted in FIG. 8A (using similarly weighted objectives), such that data points 712a are weighted very low, data points 712b are weighted low, data points 712c are weighted medium, data points 712d are weighted high, and data points 712e are weighted very high. Data points 712f are also weighted medium.

In the example of FIG. 8B, the pareto-optimal data points 712 are weighted so that solutions with greater dog leg severity are prioritized, resulting in different classifications. Specifically, the data points 712a, 712b, 712c and 712e are weighted very high, and data points 712d are weighted high. Data points 712g are weighted low, and a data points 712h is weighted medium. The data points 712f are weighted very low in the example of FIG. 8B.

It can be observed by comparing FIGS. 8A and 8B that the classification of some or all of the pareto-optimal solutions changes depending on the weighting. The weighting technique may be performed as shown in Eq. 3.

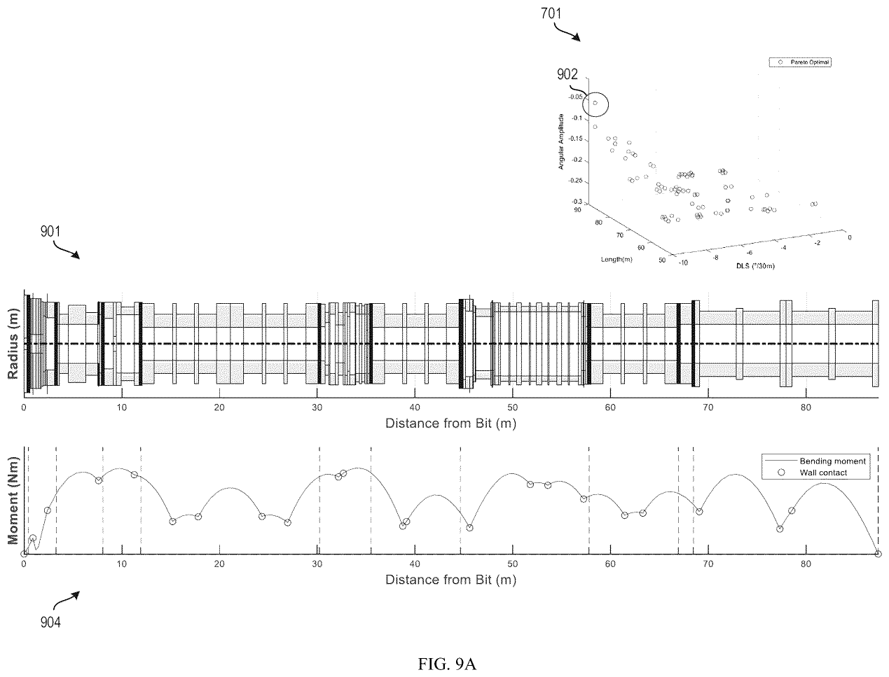

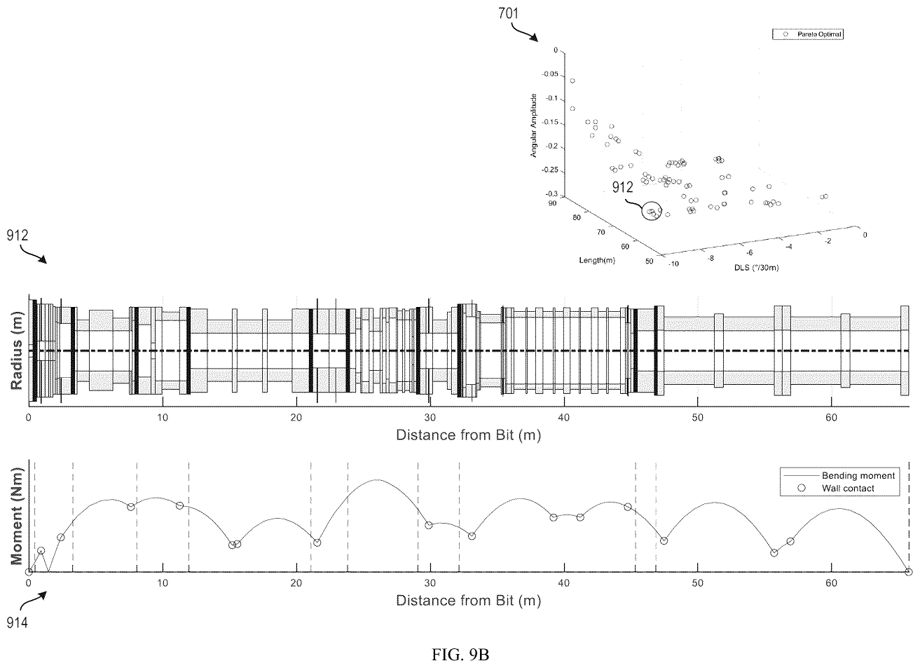

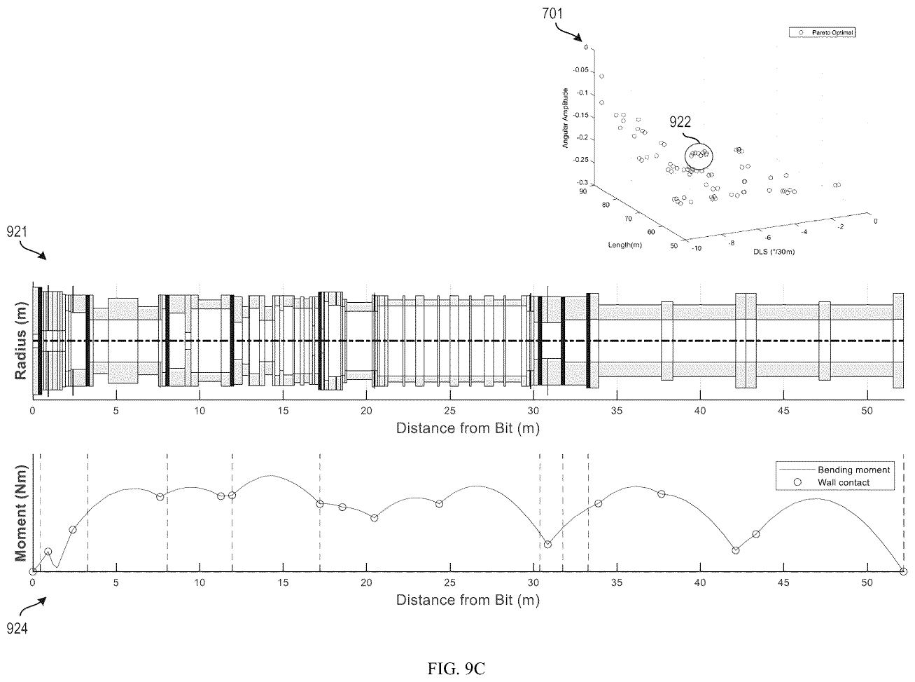

FIGS. 9A, 9B, and 9C depict examples of BHA designs 901, 911, 921 according to one or more embodiments described herein.

In the example of FIG. 9A, the BHA design 901 is shown in terms of distance from bit (meters) along the BHA and radius (meters) of the BHA, with each of the included components. The BHA design 901 represents the point 902 selected from the objective function solution space shown in the graphs 701, 702 of FIGS. 7A and 7B. A graph 904 is also shown that plots distance from bit (meters) against bending moment (Newton meters) along the BHA at a dogleg severity of −9.92°/100 feet.

In the example of FIG. 9B, the BHA design 912 is shown in terms of distance from bit (meters) along the BHA and radius (meters) of the BHA, with each of the included components. The BHA design 912 represents the point 912 selected from the objective function solution space shown in the graphs 701, 702 of FIGS. 7A and 7B. A graph 914 is also shown that plots distance from bit (meters) against bending moment (Newton meters) along the BHA at a dogleg severity of −8.83°/100 feet.

In the example of FIG. 9C, the BHA design 921 is shown in terms of distance from bit (meters) along the BHA and radius (meters) of the BHA, with each of the included components. The BHA design 921 represents the point 922 selected from the objective function solution space shown in the graphs 701, 702 of FIGS. 7A and 7B. A graph 924 is also shown that plots distance from bit (meters) against bending moment (Newton meters) along the BHA at a dogleg severity of −9.28 °/100 feet.

One or more embodiments as described herein were tested on a use case of a BHA for the North Africa and Levant (NAL) region. The BHA design criteria for this BHA were: a steering unit, an MWD assembly, a telemetry tool, a vibration damping device, and a motor were to be included in the BHA. The quantity and the order of the steering unit, the MWD assembly, and the telemetry tool was static. The vibration damping device and the motor could be placed anywhere within the BHA above the steering unit, the MWD assembly, and the telemetry tool. To find an optimal BHA for this case, the objectives of a maximal dogleg severity, a minimal BHA length, and a maximal angular amplitude of HFTO at a component of the vibration damping device were defined as the modeling constraints. Additional components (e.g., stabilizer subs, flex subs, and/or the like, including combinations and/or multiples thereof) were included in the component database. The optimization algorithm as described herein could place these additional components anywhere above the first three tools in the BHA to enhance a certain property of the BHA. The additional components were not restricted in their inclusion, quantity, position, etc., to result in a broad solution space. The overall number of possible permutations without any constraints exceeds one million. After integrating these constraints, the number of permutations is reduced significantly to approximately 93,750 possible BHA designs. After evaluation, the numerical optimization algorithm described herein found a pareto-front of best possible compromises of the three objective functions. The pareto front includes a portion of the data points in the solution space. Using this pareto-front, solutions for the BHA design were chosen regarding the weighting of specific objectives. This use case is merely an example and is not intended to be limiting.

Example embodiments of the disclosure include or yield various technical features, technical effects, and/or improvements to technology. Example embodiments of the disclosure provide technical solutions for automatically generating and evaluating BHA configurations, such as by using constraint handling and/or numerical optimization. As a result, a significantly higher number of BHA designs can be assessed compared to conventional approaches to designing BHAs, which are laborious and highly dependent on the experience and heuristics of the evaluators. Moreover, one or more embodiments described herein provide for eliminating non-desirable solutions to avoid having to calculate all possible permutations of components in a BHA by implementing numerical optimization and/or enhanced constraint handling. Accordingly, a more suitable BHA design may be selected and implemented. The one or more embodiments described herein are less time consuming than conventional approaches. Moreover, a more reliable and task-specific BHA design can be determined and implemented. For example, an optimal BHA design can be determined to provide a defined service while maximizing the reliability and efficiency of the BHA and minimizing a number of flex or stabilizer subs. A more reliable and efficient BHA provides for improved drilling efficiency, reducing non-production time, improving hydrocarbon recovery, and the like. This increases hydrocarbon recovery from a hydrocarbon reservoir compared to conventional techniques.

Set forth below are some embodiments of the foregoing disclosure:

Embodiment 1: A method of defining a BHA design, the method comprising: performing a numerical optimization process including: applying a bottom hole assembly (BHA) design criterion using a numerical optimization algorithm to identify a set of BHA designs selected from a plurality of possible BHA designs; evaluating multiple objective functions for each BHA design of the set of BHA designs based at least in part on a modeling constraint; and identifying a pareto-front of a solution space of the multiple objective functions using the numerical optimization algorithm; selecting a data point from the pareto-front using a cost function; selecting a BHA design from the set of BHA designs using the selected data point; and building a BHA using the selected BHA design to be deployed downhole in a wellbore.

Embodiment 2: The method according to any prior embodiment, wherein the numerical optimization algorithm is a nondominated sorting genetic algorithm, a machine learning algorithm, or a global pattern search algorithm.

Embodiment 3: The method according to any prior embodiment, wherein the BHA design criterion defines at least one BHA component to be included in the set of BHA designs.

Embodiment 4: The method according to any prior embodiment, wherein the BHA design criterion defines a position of the at least one BHA component to be included in the set of BHA designs.

Embodiment 5: The method according to any prior embodiment, wherein the BHA design criterion defines a position of a first BHA component to be included in the set of BHA designs relative to a second BHA component to be included in the set of BHA designs.

Embodiment 6: The method according to any prior embodiment, wherein at least one objective function of the multiple objective functions is selected from at least one of a maximum overall length, a minimum distance of functional elements, a maximum distance of functional elements.

Embodiment 7: The method according to any prior embodiment, wherein at least one objective function of the multiple objective functions is selected from at least one of a maximal dog leg severity, a maximal angular amplitude of a high frequency torsional oscillation, and a minimal local magnetic interference.

Embodiment 8: The method according to any prior embodiment, wherein the modeling constraint is a maximal bending moment a BHA component in the set of BHA designs can withstand.

Embodiment 9: The method according to any prior embodiment, wherein the selected data point is part of a plurality of data points in the pareto -front, further comprising applying weights to the plurality of data point in the pareto-front to generate a weighted plurality of data points in the pareto-front.

Embodiment 10: The method according to any prior embodiment, wherein the weights applied to the plurality of data points in the pareto-front prioritize at least one of multiple objectives associated with the multiple objective functions.

Embodiment 11: The method according to any prior embodiment, wherein the weighted plurality of data points in the pareto-front classify each BHA design of the set of BHA designs relative to other BHA designs of the set of BHA designs.

Embodiment 12: The method according to any prior embodiment, further comprising terminating the numerical optimization process based on determining that a termination criterion is satisfied.

Embodiment 13: The method according to any prior embodiment, further comprising storing properties of a plurality of BHA components in a database, wherein identifying the set of BHA designs includes using the database.

Embodiment 14: The according to any prior embodiment, wherein the set of BHA designs includes a first BHA design and a second BHA design, and wherein evaluating the multiple objective functions for the first BHA design results in a first data point in the solution space, and the method includes identifying the second BHA design using the first data point in the numerical optimization algorithm, wherein the second BHA design is an optimized BHA design compared to the first BHA design.

Embodiment 15: A system comprising: a memory storing computer readable instructions; and a processing device for executing the computer readable instructions, the computer readable instructions controlling the processing device to perform operations comprising: applying a bottom hole assembly (BHA) design criterion using a numerical optimization algorithm to identify a set of BHA designs selected from a plurality of possible BHA designs; evaluating multiple objective functions for each BHA design of the set of BHA designs based at least in part on a modeling constraint; identifying a pareto-front of a solution space of the multiple objective functions using the numerical optimization algorithm; selecting a data point from the pareto-front using a cost function; selecting a BHA design from the set of BHA designs using the selected data point; and building a BHA using the selected BHA design to be deployed downhole in a wellbore.

Embodiment 16: The system according to any prior embodiment, wherein the numerical optimization algorithm is a nondominated sorting genetic algorithm, a machine learning algorithm, or a global pattern search algorithm.

Embodiment 17: The system according to any prior embodiment, wherein the BHA design criterion defines a position of a first BHA component to be included in the set of BHA designs relative to a second BHA component to be included in the set of BHA designs.

Embodiment 18: The system according to any prior embodiment, wherein at least one objective function of the multiple objective functions is selected from at least one of a maximal dogleg severity, a maximal angular amplitude of a high frequency torsional oscillation, and a minimal local magnetic interference.

Embodiment 19: The system according to any prior embodiment, wherein the modeling constraint is a maximal bending moment that a BHA component in the set of BHA designs can withstand.

Embodiment 20: The system according to any prior embodiment, wherein the selected data point is part of a plurality of data points in the pareto front, and the operations include applying weights to the plurality of data points in the pareto-front.

The use of the terms “a” and “an” and “the” and similar referents in the context of describing the present disclosure (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure can be used in a variety of well operations. These operations can involve using one or more treatment agents to treat a formation, the fluids resident in a formation, a wellbore, and/or equipment in the wellbore, such as production tubing. The treatment agents can be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the present disclosure has been described with reference to an exemplary embodiment or embodiments, it will be understood by those skilled in the art that various changes can be made and equivalents can be substituted for elements thereof without departing from the scope of the present disclosure. In addition, many modifications can be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims. Also, in the drawings and the description, there have been disclosed exemplary embodiments of the present disclosure and, although specific terms can have been employed, they are unless otherwise stated used in a generic and descriptive sense only and not for purposes of limitation, the scope of the present disclosure therefore not being so limited.

What is claimed is:

1. A method of defining a BHA design, the method comprising:
performing a numerical optimization process including:
applying a bottom hole assembly (BHA) design criterion using a numerical optimization algorithm to identify a set of BHA designs selected from a plurality of possible BHA designs;
evaluating multiple objective functions for each BHA design of the set of BHA designs based at least in part on a modeling constraint; and
identifying a pareto-front of a solution space of the multiple objective functions using the numerical optimization algorithm;
selecting a data point from the pareto-front using a cost function;
selecting a BHA design from the set of BHA designs using the selected data point; and
building a BHA using the selected BHA design to be deployed downhole in a wellbore.

2. The method of claim 1, wherein the numerical optimization algorithm is a nondominated sorting genetic algorithm, a machine learning algorithm, or a global pattern search algorithm.

3. The method of claim 1, wherein the BHA design criterion defines at least one BHA component to be included in the set of BHA designs.

4. The method of claim 3, wherein the BHA design criterion defines a position of the at least one BHA component to be included in the set of BHA designs.

5. The method of claim 1, wherein the BHA design criterion defines a position of a first BHA component to be included in the set of BHA designs relative to a second BHA component to be included in the set of BHA designs.

6. The method of claim 1, wherein at least one objective function of the multiple objective functions is selected from at least one of a maximum overall length, a minimum distance of functional elements, a maximum distance of functional elements.

7. The method of claim 1, wherein at least one objective function of the multiple objective functions is selected from at least one of a maximal dog leg severity, a maximal angular amplitude of a high frequency torsional oscillation, and a minimal local magnetic interference.

8. The method of claim 1, wherein the modeling constraint is a maximal bending moment a BHA component in the set of BHA designs can withstand.

9. The method of claim 1, wherein the selected data point is part of a plurality of data points in the pareto-front, further comprising applying weights to the plurality of data point in the pareto-front to generate a weighted plurality of data points in the pareto-front.

10. The method of claim 9, wherein the weights applied to the plurality of data points in the pareto-front prioritize at least one of multiple objectives associated with the multiple objective functions.

11. The method of claim 9, wherein the weighted plurality of data points in the pareto-front classify each BHA design of the set of BHA designs relative to other BHA designs of the set of BHA designs.

12. The method of claim 1, further comprising terminating the numerical optimization process based on determining that a termination criterion is satisfied.

13. The method of claim 1, further comprising storing properties of a plurality of BHA components in a database, wherein identifying the set of BHA designs includes using the database.

14. The method of claim 1, wherein the set of BHA designs includes a first BHA design and a second BHA design, and wherein evaluating the multiple objective functions for the first BHA design results in a first data point in the solution space, and the method includes identifying the second BHA design using the first data point in the numerical optimization algorithm, wherein the second BHA design is an optimized BHA design compared to the first BHA design.

15. A system comprising:
a memory storing computer readable instructions; and
a processing device for executing the computer readable instructions, the computer readable instructions controlling the processing device to perform operations comprising:
applying a bottom hole assembly (BHA) design criterion using a numerical optimization algorithm to identify a set of BHA designs selected from a plurality of possible BHA designs;
evaluating multiple objective functions for each BHA design of the set of BHA designs based at least in part on a modeling constraint;
identifying a pareto-front of a solution space of the multiple objective functions using the numerical optimization algorithm;
selecting a data point from the pareto-front using a cost function;
selecting a BHA design from the set of BHA designs using the selected data point; and
building a BHA using the selected BHA design to be deployed downhole in a wellbore.

16. The system of claim 15, wherein the numerical optimization algorithm is a nondominated sorting genetic algorithm, a machine learning algorithm, or a global pattern search algorithm.

17. The system of claim 15, wherein the BHA design criterion defines a position of a first BHA component to be included in the set of BHA designs relative to a second BHA component to be included in the set of BHA designs.

18. The system of claim 15, wherein at least one objective function of the multiple objective functions is selected from at least one of a maximal dogleg severity, a maximal angular amplitude of a high frequency torsional oscillation, and a minimal local magnetic interference.

19. The system of claim 15, wherein the modeling constraint is a maximal bending moment that a BHA component in the set of BHA designs can withstand.

20. The system of claim 15, wherein the selected data point is part of a plurality of data points in the pareto front, and the operations include applying weights to the plurality of data points in the pareto-front.
